(19) United States
(12) Patent Application Publication
(10) Pub. No.: US 2010/0316294 A1
(43) Pub. Date: Dec. 16, 2010

(54) Method and Data Processing System for Creating Image Segmentation Models

(76) Inventor: Petra Perner, Leipzig (DE)

Correspondence Address: GUDRUN E. HUCKETT DRAUDT, SCHUBERTSTR. 15A, WUPPERTAL, 42289, DE

(21) Appl. No.: 12/528,322

(22) PCT Filed: Feb. 22, 2008
(86) PCT No.: PCT/DE08/00337

§ 371 Date: Aug. 22, 2009

(30) Foreign Application Priority Data
Feb. 22, 2007 (DE) 10 2007 009 485.1

(51) Int. Cl. G06K 9/34

(52) U.S. Cl. 382/173

(57) ABSTRACT

Image segmentation is realized from the actual image based on image features and a most similar case. The characteristic of the actual image is compared to characteristics of images of a case database. The most similar image in the case database is determined by a similarity quantity, and the parameters correlated with the most similar case are the basis for image segmentation. The actual image is segmented with these parameters, preferably by watershed transformation. The segmented image is evaluated and according to the evaluation in the case database as a case with the parameters of the image segmentation device and the characteristics of the image is saved as a new case in the case database. The model creation is realized by incremental addition of new cases, by a refinement based on generalization of the cases of the case database, by learning similarity, or by at least one combination thereof.

The invention concerns methods and data processing systems for model creation for the image segmentation of digital images, computer program products with a program code, respectively, for performing these methods, and computer program products on machine-readable carriers for performing these methods.

Arrangements for automated examination of cells, cell complexes and other biological samples are disclosed, inter alia, in DE 196 16 997 A1 (Method for automated microscope-supported examination of tissue samples or bodily fluid samples), DE 42 11 904 A1 (Method and device for generating a type list for a liquid sample), and DE 196 39 884 A1 (Pattern recognition system).

In DE 196 16 997 A1 tissue samples or bodily fluid samples are examined with respect to cell types through the application of neuronal networks.

Smallest living beings such as worms, insects or snails are detected and identified in DE 42 11 904 A1. The identification is carried out by comparison with objects contained in a reference object memory. At the same time, the identified objects are counted and recorded in a type list.

In DE 196 39 884 A1 solid components are detected in a sample flow according to size, in particular in accordance with their projection length in the image along the X and the Y axes, their circumference and their average color density.

A disadvantage is the lack of a possibility of automated processing.

DE 10 2004 018 174 (Method for acquisition of shapes of images with cases and case-based recognition of objects in digital images, computer program product, and digital memory medium for performing this method) discloses methods for acquisition of shapes of images with cases and case-based recognition of objects in digital images, computer program products each with a program code for performing this method, computer program products on machine-readable carriers for performing this method, and digital memory media that can interact with a programmable computer system in such a way that these methods are performed. The methods are characterized in particular in that the semi-automated individual shapes of cases in images are detected, that automatically, based on these individual shapes, abstract shape models of various abstraction levels are obtained and that automatically objects can be determined. The learned abstract shape models are either average shapes of groups of cases or medians as individual shapes of groups of cases. Unknown objects cannot be identified and interpreted automatically; evaluations of unknown objects cannot be done automatically.

The invention disclosed in claims 1, 6, 11, and 12 has the object to automatically create models for image segmentation of digital images.

This object is solved by the features disclosed in claims 1, 6, 11, and 12.

The methods and data processing systems for model creation for image segmentation of digital images is characterized in particular in that the models for the image segmentation are created automatically from digital images.

For this purpose, the image segmentation of the image is carried out based on image features and a selection of the most similar case from a case database wherein the characteristic of the actual image is compared with characteristics of images of the case database, by means of a similarity quantity the most similar image in the case database is determined, and the parameters correlated with the most similar case are the basis for the image segmentation of the actual image. Moreover, the actual image is segmented with these parameters preferably by means of the watershed transformation. Instead of the watershed transformation, it is also possible to employ the threshold value method, filter method, or snakes method.

The segmented image is further evaluated and, in accordance with the evaluation in the case database as a case with the parameters of the image segmentation device and the characteristics of the image saved as a new case in the case database.

Moreover, the model creation is realized by incremental addition of new cases by incremental addition of new cases, by refinement by means of generalization of the cases contained in the case database, by learning the similarity, or by at least one combination thereof.

In this way, the parameters of the generalized case can be employed across a larger quantity of images.

The evaluation can be done manually and/or automatically. In the case of manual evaluation the digital image as original image and the segmented image are represented on a monitor screen so that an evaluation of the quality of segmentation can be done. For automated evaluation, for example, the edges of the digital image can be segmented and a binary value can be assigned. By comparing this segmented image with the image that is currently segmented by the method, the quality of segmentation is determined based on a similarity quantity.

Accordingly, the methods and data processing systems are suitable for automated model creation. These models serve for automated recognition in particular of objects in images.

In that the images are compared continuously with saved models, advantageously an improvement of the models is realized, wherein, for example, different appearance shapes of objects of the same type are also automatically recognized and assigned as models. In this way, the methods and data processing systems advantageously are suitable for digital images with biological objects.

This is in particular of interest for evaluating the health of persons. Diseases and their courses can be specifically followed and applied in the future to same or similar courses so that the diagnostics are improved. Basis for this are inter alia images of cell sections, cells, cell conglomerates, organs up to entire bodies.

In medicine, diseases and their courses can be determined and with respect to their course can be followed by determination of the state of cells directly or by means of cell sections, for example, in the form of HEp-2 cell sections.

By means of HEp-2 cell sections, for example, autoimmune diseases are detectable that are characterized by a reactivity of the immune system with respect to the body's own substances and structures. A frequent feature in case of such diseases is the occurrence of auto-antibodies as immunoglobulin that are targeting the body's own structures. In addition to organ-specific auto-antibodies, in particular non-organ-specific auto-antibodies with reactivity against cellular structures are important. The detection of such auto-antibodies has great diagnostic significance.

Moreover, the methods and data processing systems can also be advantageously employed for detecting malaria. After a human being has been bitten by an infected Anapholes mosquito, it secrets with its saliva so-called sporozoites. From these, in the liver tissue so-called merozoites are formed. The latter reach, after bursting of the shizont, the blood stream where they attack red blood cells. They penetrate into the latter and transform into annular shapes that ripen to a trophozoite. For diagnosis, normal blood slides are utilized wherein a differentiation of the plasmodia is indicated by application of the methods and data processing systems wherein the plasmodia can be determined based on their contour, shape and texture. The parasite count and leucocyte count are a measure for the severity of the disease.

The methods and data processing systems can moreover advantageously serve for automated evaluation of medical section images in the form of, for example, computer tomographs with regard to detecting objects and structures. Such objects are, for example, the brain tissue or cerebrospinal fluid in the cranium. In this way, a detection and course control of diseases that entail a change of organs can be followed. For example, this is the brain whose size and structure inter alia changes in case of Alzheimer's disease.

Moreover, the methods and data processing systems can be employed for detection of the presence of particles and the development of microorganisms or fungal spores as biotic particles. In this way, for example, the atmosphere inside and outside of buildings can be monitored. Advantageously, an automated detection is realized so that in particular a very fast determination of the presence of fungal spores and the identification of the type of certain fungal spores in accordance with the models is enabled. For this purpose, the particles are collected on a carrier surface and the image of the collected particles is recorded. These steps can be automated easily so that an automated monitoring is present.

The methods and data processing systems can also be used for quantitative detection and quantitative evaluation of seeds, fruits or other foodstuff. Disease-inflicted or damaged seeds, fruits or foodstuff or parts thereof can be automatically detected. For example, in the case of grains split-open grains, grain outgrowth, laterally incomplete husk formation, husk-damaged grains, twin growth, green grains, intact red grains, damaged red grains, and oat grass are quality flaws. Of course, intact grains, fruits or foodstuffs are also determined in this context. This also includes their size. Accordingly, they can be quantitatively examined with regard to quality categories. The detection is done very fast so that even delivered quantities can be examined promptly with regard to their quality and, for example, a decision with respect to accepting or refusing a delivery can be done within a short period of time. For possible claims, the results can be provided easily with documentation. This can be the date, the supplier, and possible the number of a delivery.

In addition to these biological objects as models, of course also most varied recorded technical objects can be recognized as models of digital images individually or in various combinations.

When employing the methods and data processing systems, in particular the contour, the shape, and the texture of objects in the digital image are taken into account. This includes all edges also within the objects.

A similarity quantity for the method and the data processing systems is, for example, the city block metric or the Euclidian distance.

The input of the data processing system for the digital image is coupled directly as well as by means of a serial connection of a module for determining image features and a module for selecting the most similar case from a case database with an image segmentation device, wherein the characteristic of the actual image is compared with characteristics of images of a case database, the most similar image in the case database is determined by means of a similarity quantity, the parameters that are correlated with the most similar case are the basis for the image segmentation of the actual digital image, preferably done by means of watershed transformation, the segmented image is evaluated and in accordance with the evaluation is saved in the case database as a case with the parameters of the image segmentation device and the characteristics of the image as a new case in the case database, and the model creation by incremental addition of new cases, by refining by means of generalization of the cases contained in the case database, by learning the similarity, or by at least one combination thereof.

In this way, the methods and data processing systems are universally applicable. They can be used for determining the presence of certain objects as well as monitoring and checking.

The methods according to the invention can be made available to the users advantageously as computer program products with a program code each for performing these methods and as computer program products on machine-readable carriers for performing these methods.

Advantageous embodiments according to the invention are disclosed in claims 2 to 5 and 7 to 15.

According to the embodiment of claim 2, the over-segmentation that occurs for the watershed transformation is reduced by a parameter-controlled fusion process.

The control of the fusion process can be, for example, realized by means of the similarity of the basins, wherein the ratio to the calculated threshold and weighted by a factor as well as summed with the depth relative to a threshold value multiplied with a weight is determined and correlated with a predetermined threshold.

The parameters for the image segmentation according to the embodiment of claim 3 are derived from the characteristics of the image and/or created by means of feature extraction methods. Moreover, characteristics of the digital images are statistical and/or structural features as well as knowledge of the images and/or the image origination process and/or the ambient characteristics.

According to the embodiment of claim 4, the case is generated of the parameters of the image segmentation device during image segmentation and the characteristics of the image. This case is saved moreover in the case database.

According to the embodiment of claim 5, these are digital images containing biological and/or technical objects, wherein biological objects preferably are images of cells, cell sections, cell conglomerates, spores, fungi, living beings or parts thereof.

The module for determining the image features and the module for selecting the most similar case, according to the embodiment of claim 7, are coupled to the case database by a module for case query, case evaluation and naming.

The segmented image according to the embodiment of claim 8 is evaluated and subsequently saved as a new case in the case database, treated case-based in the case database as a case with the parameters of the image segmentation device and the characteristics of the image, wherein the case is created of the parameters of the image segmentation device during image segmentation and the characteristics of the image and is saved in the case database.

According to the embodiment of claim 9, a module for evaluation of the image segmentation device and a module for case-based treatment are connected downstream of the image segmentation device, wherein the parameters of the image segmentation device after image segmentation and the characteristics of the image are the basis.

According to the embodiment of claim 10, for model creation a knowledge module with the image segmentations and the image characteristics is connected to the case database by means of interconnected modules of case creation and case improvement and by means of an interconnected module for selective case input. Moreover, the module for selective case input and the case database are coupled with a module for case generalization.

Moreover, the case database is connected by means of a module for updating the case input to the interconnected modules of case creation and case improvement such that a continuous update by addition of the contents of the knowledge module is provided.

One embodiment of the invention is illustrated schematically in the drawings, respectively, and will be explained the following in more detail.

It is shown in:

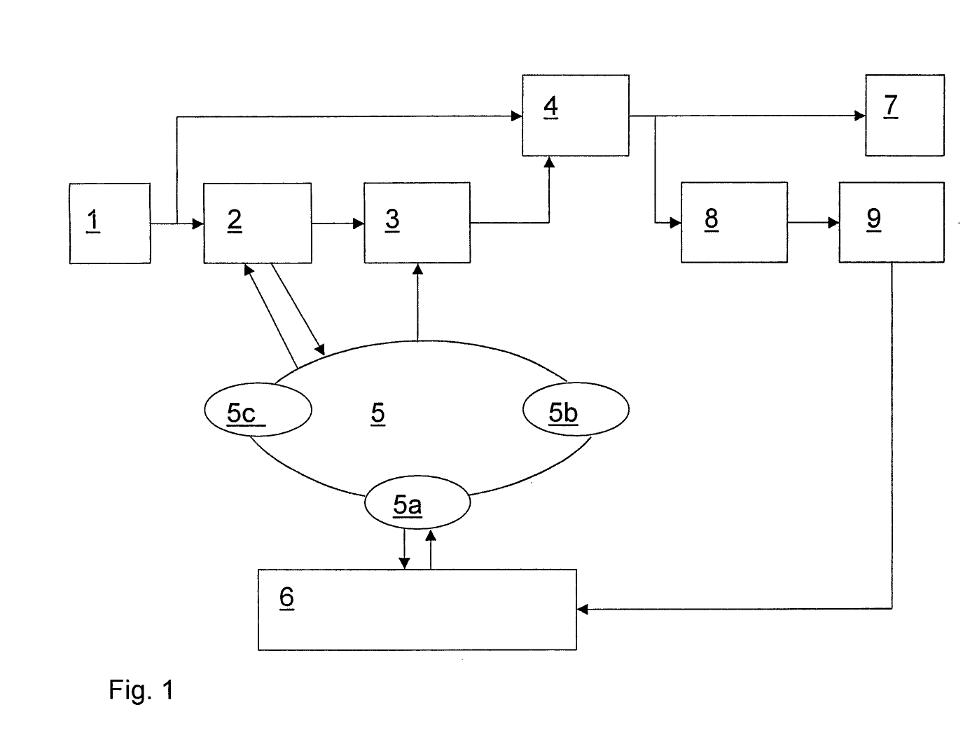

FIG. 1 a data processing system for model creation for image segmentation of digital images; and

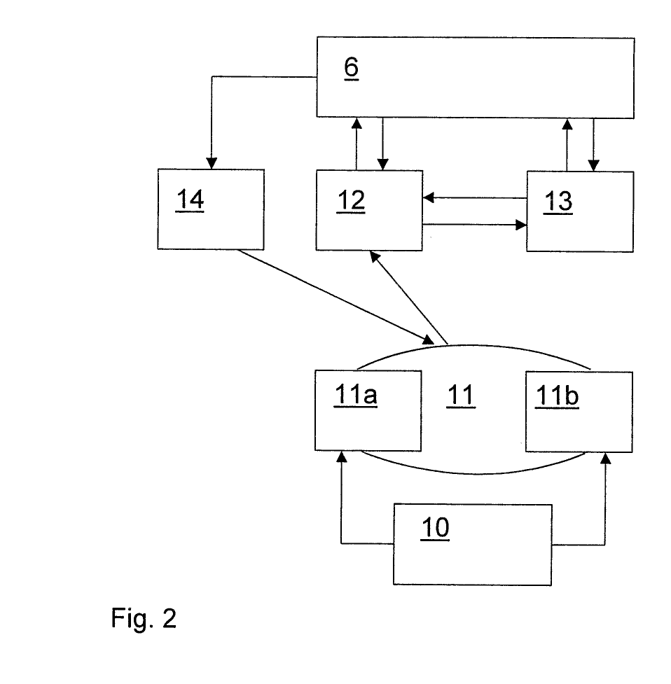

FIG. 2 a model-creating component of the data processing system.

In the following embodiment a method and a data processing system for model creation for the image segmentation of digital images will be explained together in more detail.

The data processing system for model creation for image segmentation of digital images 1 is comprised substantially of an image segmentation device 4, a module 2 for determining image features, a module 3 for selecting the most similar case, a module 5 for case query, case evaluation, and naming, and a case database 6.

FIG. 1 shows a data processing system for model creation for the image segmentation of digital images in a schematic illustration.

In the data processing system by means of the image features and a selection of the most similar case from the case database 6 the image segmentation of an image 1 is carried out, wherein the characteristic of the actual image is compared to characteristics of images of a case database 6, by means of a similarity quantity, for example, the city block metric, the most similar image in the case database 6 is determined, and the parameters correlated with the most similar case are used as the basis for image segmentation of the actual image. The actual image is segmented based on these parameters by means of the watershed transformation.

For this purpose, the input of the data processing system for the image 1 is interconnected directly as well as by means of a serial connection of the module 2 for determining the image features and the module 3 for selecting the most similar case of the case database 6 with the image segmentation device.

An over-segmentation occurring for the watershed transformation is reduced by a parameter-controlled fusion process. The control of the fusion process is realized by means of similarity of the basins, wherein the ratio to the calculated threshold and weighted by a factor as well as summed with the depth relative to a threshold value multiplied with a weight is determined and correlated with a predetermined threshold.

The parameters of the image segmentation are derived from the characteristics of the image wherein the characteristics are statistical and/or structural features. In the watershed transformation, for example, the grayscale image of the actual image is processed by calculation of threshold values in the form of the depth of the basins as well as the difference of the height of the basins. The basins, in case of existence of at least one non-weak significant basin and non-existence of at least one non-strong significant basin, are characterized by means of calculation of new threshold values and comparison with the existing threshold values.

The segmented image 7 is evaluated and in accordance with the evaluation is saved in the case database 6 as a case with the parameters of the image segmentation device 4 and characteristics of the image 1 as a new case in the case database 6. In this connection, the case is created based on the parameters of the image segmentation device 4 for the image segmentation and the characteristics of the image 1.

For this purpose, a module 8 for evaluation of the image segmentation device and a module 9 for case-based treatment are connected downstream of the image segmentation device 4, wherein the parameters of the image segmentation device 4 after image segmentation and the characteristics of the image 1 are the basis.

The cases of the case database 6 are moreover automatically updated on the basis of the parameters of the image segmentation device 4 for image segmentation and the characteristics of the image 1.

For this purpose the module 2 for detecting the image features and the module 3 for selecting the most similar case are interconnected with the case database 6 by means of the module 5 for case query 5a, case evaluation 5b, and identification 5c.

For model creation a knowledge module 10 with the image segmentations and the image characteristics is connected to the case database 6 by means of interconnected module of case creation 11a and case improvement 11b and by means of module 12 for selective case input connected thereto. The model creation is done by incremental addition of new cases and refinement by means of generalization of the cases contained in the case database so that the parameters of the generalized case are applicable to a larger quantity of images. Learning the similarity has moreover the effect that the segmentation parameters are applicable for a larger quantity of images. The module 12 for selective case input and the case database 6 are interconnected with a module 13 for case generalization. The case database 6 is moreover connected by a module 14 for updating the case entry with the interconnected modules of case creation 11a and case improvement 11b so that a continuous update with addition of the contents of the knowledge module 10 is provided.

FIG. 2 shows a model-creating component of the data processing system in a schematic illustration.

What is claimed is:

1.-12. (canceled)

13. A method for model creation for image segmentation of digital images, the method comprising the steps of:
carrying out image segmentation of an actual image in an image segmentation device based on image features of the image and a most similar case selected from a case database, wherein the most similar case is selected by comparing the characteristic of the actual image to characteristics of images of the case database and determining the most similar image in the case database based on a similarity quantity, wherein the actual image is segmented to a segmented image based on parameters that are correlated with the most similar case;
evaluating the segmented image and, according to the evaluation in the case database as a case with the parameters of the image segmentation device and the characteristics of the image, saving the case as a new case in the case database; and
performing model creation by incremental addition of new cases, by refinement based on generalization of the cases contained in the case database, by learning the similarity, or by at least one combination thereof.

14. The method according to claim 13, wherein the image segmentation is performed by watershed transformation,

15. The method according to claim 14, wherein over-segmentation that occurs in the watershed transformation is reduced by a parameter-controlled fusion process.

16. The method according to claim 13, wherein the parameters for image segmentation are derived from at least one of the characteristics of the image and feature extraction methods, wherein the characteristics of the images are selected from at least one of statistical features, structural features, knowledge of the images, the image origination process, and the ambient characteristics.

17. The method according to claim 13, wherein a case is created from the parameters of the image segmentation device during the image segmentation and the characteristics of the images and the case is saved in the case database.

18. The method according to claim 13, wherein the actual image is a digital image with biological and/or technical objects, wherein biological objects are preferably images of cells, cell sections, cell conglomerates, fungi, foodstuffs, living beings or parts thereof.

19. A data processing system for performing the method according to claim 13, comprising;
a case database;
a module for determining image features;
a module for selecting the most similar case of the case database;
an image segmentation device;
wherein an input of the data processing system for the actual image is connected directly and by a serial connection of the module for determining image features and the module for selecting the most similar case of the case database to the image segmentation device;
wherein the characteristics of the actual image are compared with characteristics of images of the case database, the most similar image in the case database is determined by a similarity quantity, the parameters correlated with the most similar case are the basis for the image segmentation of the actual image, the segmented image is evaluated and in accordance with the evaluation in the case database as a case with the parameters of the image segmentation device and the characteristics of the image is saved as a new case in the case database, and the model creation is realized by incremental addition of new cases, by a refinement by means of generalization of the cases contained in the case database, by learning the similarity, or by at least one combination thereof.

20. The data processing system according to claim 19, wherein the image segmentation is done by watershed transformation.

21. The data processing system according to claim 19, further comprising a module for case query, case evaluation, and naming, wherein the module for determining the image features and the module for selecting the most similar case are interconnected with the case database by the module for case query, case evaluation, and naming.

22. The data processing system according to claim 19, wherein the segmented image is evaluated and subsequently saved as a new case in the case database, treated case-based in the case database as a case with the parameters of the image segmentation device and the characteristics of the image, wherein the case is created from the parameters of the image segmentation device during image segmentation and the characteristics of the image and saved in the case database.

23. The data processing system according to claim 22, further comprising a module for evaluating the image segmentation device and a module for case-based treatment, wherein the module for evaluating the image segmentation device and the module for case-based treatment are connected downstream of the image segmentation device, wherein the parameters of the image segmentation device after image segmentation and the characteristics of the image are the basis for evaluation.

24. The data processing system according to claim 19, further comprising:
a knowledge module with the image segmentations and the image characteristics;
a module of case creation and case improvement;
a module for selective case input connected to the module of case creation and case improvement;
a module for case generalization;
a module for updating the case entry;
wherein the knowledge module is connected by the interconnected module of case creation and case improvement and the module for selective case input to the case database;
wherein the module for selective case input and the case database are interconnected with the module for case generalization; and
wherein the case database is connected by the module for updating the case entry to the interconnected module of case creation and case improvement so that a continuous update with addition of the contents of the knowledge module is provided.

25. A computer program product with a program code for performing the method according to claim 13, when the program is running on a computer.

26. A computer program product on a machine-readable carrier for performing the method according to claim 13, when the program is running on a computer.
